(19) United States
(12) Patent Application Publication
(10) Pub. No.: US 2003/0188230 A1
(43) Pub. Date: Oct. 2, 2003

(54) Operation monitoring apparatus and operation monitoring program storage medium

(75) Inventor: Yasuto Ezure, Hiroshima (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/255,603

(22) Filed: Sep. 27, 2002

(30) Foreign Application Priority Data
Mar. 27, 2002 (JP) 2002-087680

(51) Int. Cl. H04B 1/74

(52) U.S. Cl. 714/47

(57) ABSTRACT

To provide an operation monitoring apparatus capable of automatically and reliably monitoring an operation of a server connected through a communication line and an operation of a database accessed by the server, and an operation monitoring program storage medium for configuring the operation monitoring apparatus on a computer. There are provided an environment definition file storage module 11 for storing an environment definition file 17 including information identifying files to be accessed for operation monitoring among files 3A, 3B, 3C, . . . contained in servers 2A, 2B, 2C, . . . connected through a communication line 6 and associated information identifying data contained in the files, a sever access module 12 for accessing the servers to retrieve the files identified in the environment definition file 17, and a data presence determination module 13 for determining whether the retrieved files contain the data identified in the environment definition file 17.

### BACKGROUND OF THE INVENTION

1. Field of the Invention

The present invention relates to an apparatus and program storage medium for monitoring the operation of a server connected through a communication line.

2. Description of the Related Art

To monitor the operational status of a server connected through a communication line, one must access each of computers, including the server, that form the network system to activate an application program on each of the computers and check to see if the application program operates properly. Typically, this checking is performed on a regular basis, for example, before starting work every day.

If the network system includes a large number of computers or a many types of application programs are running on the computers, the regular checking is burdensome and it is difficult to reliably monitor the operational status of the server.

Most network systems today include databases. In such a system, it is insufficient to monitor the operational status of computers alone that are interconnected through a communication line. The operational status of the database systems linked to the computers must also be monitored. As a result, the monitoring may be further complicated.

There are tools for monitoring the operational status of an underlying system software such as an OS (operating system) and RDBMS (Relational Database Management System). However, each tool of these tools can monitor only one software program. Furthermore, to monitor whether application programs such as a WWW (World Wide Web) server and DB (Database) access program running on those programs are operating properly, different operation monitoring systems must be developed for the different application programs.

### SUMMARY OF THE INVENTION

In view of the above-described circumstances, an object of the present invention is to provide an operation monitoring apparatus capable of automatically and reliably monitoring the operation of a server connected through a communication line and a database accessed by the server and an operation monitoring program storage medium on which an operation monitoring program for configuring the operation monitoring apparatus on a computer.

A first operation monitoring apparatus according to the present invention that achieves the above-described object is an operation monitoring apparatus for monitoring the operation of a server connected through a communication line, comprising: an environment definition file storage module for storing an environment definition file including information identifying a file to be accessed for operation monitoring among files contained in the server connected through the communication line and information identifying data contained in the file, the information identifying the file being associated with the information identifying the data; a server access module for accessing the above-described server to retrieve a file identified in the environment definition file stored in the environment definition file storage module in the server; and a data presence determination module for determining whether the file retrieved by the server access module contains the data identified in the environment definition file stored in the environment definition file storage module.

The term “communication line” as used herein refers to a network such as an Internet, an intranet, WAN (Wide Area Network), or LAN (Local Area Network), for example.

The first operation monitoring apparatus of the present invention can implement an operation monitoring apparatus capable of automatically and reliably monitoring the operation of a server connected through a communication line by the provision of the environment definition file storage module, server access module, and data presence determination module.

A second operation monitoring apparatus according to the present invention that attains the above-described object is an operation monitoring apparatus for monitoring the operation of a database accessed by a server connected through a communication line, comprising: an environment definition file storage module for storing an environment definition file including information identifying an application program for retrieving data used for operation monitoring among data contained in the database provided in and accessed by the server connected through the communication line and information identifying data to be retrieved by the application program from the database, the information identifying the application program being associated with the information identifying the data, a server access module for accessing the server to activate the application program identified in the environment definition file stored in the environment definition file storage module in the server and obtaining the data from the database through the server; and a data presence determination module for determining whether the data obtained by the server access module contains the data identified in the environment definition file stored in the environment definition file storage module.

The second operation monitoring apparatus of the present invention can implement an operation monitoring apparatus capable of automatically and reliably monitoring the operation of a database accessed by a server connected through a communication line by the provision of the environment definition file storage module, server access module, and data presence determination module.

Preferably, the environment definition file allows information identifying recovery means for causing the sever to perform recovery to be described in the environment definition file and the first and second operation monitoring apparatuses include a recovery module for causing the server to perform recovery based on the information identifying the recovery means if the data presence determination module determines that the data identified in the environment definition file is not contained.

In this configuration, the operation monitoring apparatus can include server recovery capability, in addition to the capability of monitoring the operation of the server.

In a preferred embodiment, the operation monitoring apparatus according to the present invention includes a log file generation module for generating a log file in which the process of determination of the data presence determination module is stored.

This configuration is useful for maintenance of servers because the process of the determination made by the data presence determination module are preserved.

In a preferred embodiment, the environment definition file allows alarm information to be described in the environment definition file and the first and second operation monitoring apparatuses include an alarm output module for outputting an alarm based on the alarm information if the data presence determination module determines that the identified data is not contained.

In this configuration, any types of alarm operation can be automatically activated, including e-mail sendout, pager message sendout, system reboot, and presentation of an alarm message on a display.

In a preferred embodiment, the server is a WWW server.

In this configuration, the operation of WWW servers on an Internet or an intranet can be monitored.

Further the information in the environment definition file that identifies the file or application program is preferably a URL (Uniform Resource Locator).

In this configuration the location of servers on an Internet or an intranet can be accurately identified and their operation can be reliably monitored.

A first operation monitoring program storage medium according to the present invention that attains the above-described object is an operation monitoring program storage medium storing an operation monitoring program causing a computer to operate as an operation monitoring apparatus for monitoring the operation of a server connected to the computer through a communication line, the operation monitoring apparatus comprising: an environment definition file storage module for storing an environment definition file including information identifying a file to be accessed for operation monitoring among files contained in the server connected through the communication line and information identifying data contained in the file, the information identifying the file being associated with the information identifying the data; a server access module for accessing the server to retrieve a file identified in the environment definition file stored in the environment definition file storage module in the server; and a data presence determination module for determining whether the file retrieved by the server access module contains the data identified by the environment definition file stored in the environment definition file storage module.

The operation monitoring program stored on the first operation monitoring program storage medium of the present invention can easily configure on a computer an operation monitoring apparatus capable of automatically and reliably monitoring the operation of servers connected through a communication line.

A second operation monitoring program storage medium according to the present invention that attains the above-described object is an operation monitoring program storage medium storing an operation monitoring program for causing a computer to operate as an operation monitoring apparatus for monitoring the operation of databases accessed by a server connected to the computer through a communication line, the operation monitoring apparatus comprising: an environment definition file storage module for storing an environment definition file including information identifying an application program for retrieving data used for operation monitoring among data contained in the database provided in and accessed by the server connected through the communication line and information identifying data to be retrieved by the application program from the database, the information identifying the application program being associated with the information identifying the data, a server access module for accessing the server to activate the application program identified in the environment definition file stored in the environment definition file storage module in the server and obtaining the data from the database through the server; and a data presence determination module for determining whether the data obtained by the server access module contains the data identified in the environment definition file stored in the environment definition file storage module.

The operation monitoring program stored on the second operation monitoring program storage medium of the present invention can easily configure on a computer an operation monitoring apparatus capable of automatically and reliably monitoring the operation of databases accessed by servers connected through a communication line.

### BRIEF DESCRIPTION OF THE DRAWINGS

FIG. 1 shows a schematic configuration diagram of one embodiment according to a first operation monitoring apparatus of the present invention.

FIG. 2 shows a schematic configuration diagram of one embodiment according to a second operation monitoring apparatus of the present invention.

FIG. 3 shows an external perspective view of an operation monitoring computer functioning as an operation monitoring apparatus according to one embodiment of the present invention.

FIG. 4 shows a hardware configuration diagram of an operation monitoring computer 100 shown in FIG. 3.

FIG. 5 shows a schematic diagram of an operation monitoring program stored in a first operation monitoring program storage medium according to one embodiment of the present invention.

FIG. 6 shows a main flowchart of an operation of the operation monitoring apparatus according to the embodiment.

FIG. 7 shows a part of an environment definition file according to the embodiment.

FIG. 8 shows a part of an alarm information list according to the embodiment.

FIG. 9 shows contents of an OK file used in the embodiment.

FIG. 10 shows a part of a flowchart indicating a “process on an nth line” of a main flowchart in FIG. 6.

FIG. 11 shows a part of a the flowchart indicating a “process on the nth line” of the main flowchart in FIG. 6.

FIG. 12 shows a part of a log file used in the embodiment.

FIG. 13 shows a flowchart of an operation performed by a time-of-day activator used in the operation monitoring apparatus according to the embodiment.

### DETAILED DESCRIPTION OF THE PREFERRED EMBODIMENTS

Embodiments of the present invention will be described below.

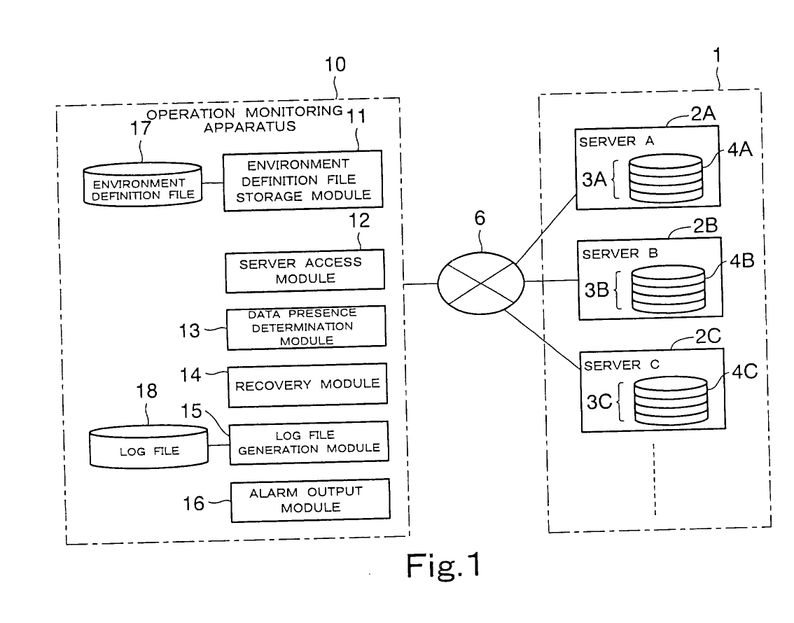

FIG. 1 shows a schematic configuration diagram of one embodiment according to the first operation monitoring apparatus of the present invention.

As shown in FIG. 1, and operation monitoring apparatus 10 includes environment definition file storage module 11, a server access module 12, and data presence determination module 13 and monitors the operations of servers 2A, 2B, 2C, . . . on a network system 1 connected over an Internet 6.

The environment definition file storage module 11 stores an environment definition file 17 including information for identifying files 4A, 4B, 4C, . . . that are accessed for operation monitoring among files 3A, 3B, 3C, . . . on the servers 2A, 2B, 2C, . . . connected through the Internet 6 and information which is associated with that information for identifying files 4A, 4B, 4C, . . . and identifies data in the files 4A, 4B, 4C, . . . .

The server access module 12 accesses the servers 2A, 2B, and 2C, . . . to retrieve the files 4A, 4B, 4C, . . . identified in the environment definition file 17 stored in the environment definition file storage module 11 on the server 2A, 2B, 2C, . . . .

The data presence determination module 13 determines whether data identified in the environment definition file 17 stored in the environment definition file storage module 11 is contained in a file retrieved by the server access module 12.

The above-described Internet 6 represents a communication line as used herein.

The operation monitoring apparatus 10 of this embodiment includes a recovery module 14, a log file generation module 15, and an alarm output module 16, in addition to the above described components.

The recovery module 14 causes servers 2A, 2B, 2C, . . . to perform recovery if the data presence determination module 13 determines that data identified in the environment definition file 17 does not exists. The environment definition file 17 of this embodiment allows information identifying recovery means to be described in it for causing servers 2A, 2B, 2C, . . . to perform recovery. The recovery module 14 performs the recovery of servers 2A, 2B, 2C, . . . based on the information identifying the recovery means.

The log file generation module 15 generates a log file 18 for storing process of determination made by the date presence determination module 13 as to whether a file obtained by the server access module 12 contains data identified in the environment definition file 17.

The alarm output module 16 provides an alarm based on the alarm information if the data presence determination module determines that identified data does not exists. The environment definition file 17 in this embodiment allows the alarm information to be described in it. The alarm output module 16 provides the alarm based on this described alarm information.

A second operation monitoring apparatus according to the present invention will be described below.

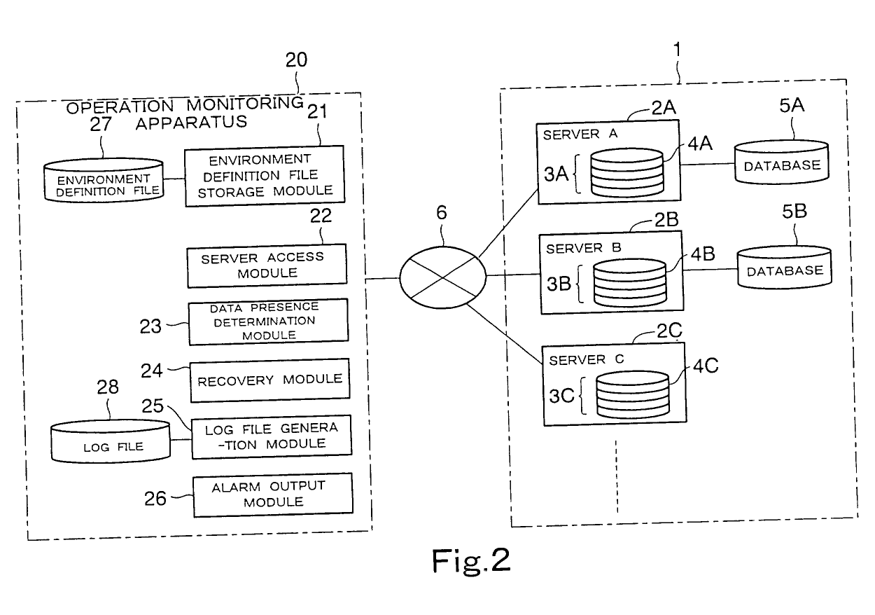

FIG. 2 schematically shows a configuration of one embodiment of the second operation monitoring apparatus according to the present invention.

As shown in FIG. 2, an operation monitoring apparatus 20 includes an environment definition file storage module 21, a server access module 22, and data presence determination module 23 and monitors the operation of databases 5A and 5B, which are accessed by servers 2A, 2B, 2C, . . . connected over the Internet 6.

The environment definition file storage module 21 stores an environment definition file 27 including information identifying an application program for retrieving data used for operation monitoring among data existing in databases 5A and 5B which are contained in and accessed by servers 2A, 2B, 2C, . . . connected over the Internet 6 and associated information identifying the data retrieved by that application program from the databases 5A and 5B.

The server access module 22 accesses servers 2A, 2B, 2C, . . . to activate the application program identified by the environment definition file 27 stored in the environment definition file storage module 21 in servers 2A , 2B, 2C, . . . and obtains data from databases 5A and 5B through the servers.

The data presence determination module 23 determines whether the data obtained by the server access module 22 contains data identified in the environment definition file 27 stored in the environment definition file storage module 21.

The operation monitoring apparatus 20 of this embodiment also includes a recovery module 24, a log file generation module 25, and an alarm output module 26, in addition to the above-described components.

The recovery module 24, log file generation module 25, and alarm output module 26 are similar to the recovery module 14, log file generation module 15, and alarm output module 16 provided in the first operation monitoring apparatus of the present invention and therefore the description of which will be omitted.

A computer on which the operation monitoring apparatus according to the present invention is configured will be described below.

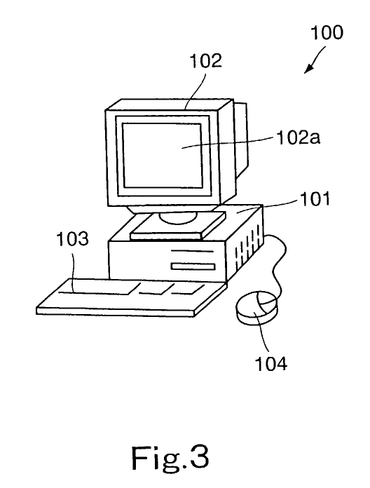

FIG. 3 shows an external perspective view of an operation monitoring computer functioning as one embodiment of the operation monitoring apparatus according to the present invention.

The operation monitoring apparatus according to this embodiment of the present invention is implemented by a combination of an operation monitoring apparatus main unit consisting of hardware of the operation monitoring computer 100 and software running within the hardware, and communication facilities, which are not shown.

The operation monitoring computer 100 includes a main unit 101 containing a CPU, RAM memory, magnetic disk, communication board, and other components, a CRT display 102 for displaying information on its display screen 102a according to directions from the main unit, a keyboard 103 for inputting an operator command and text information into the operation monitoring computer, and a mouse 104 for specifying a position on the display screen to input an instruction relevant to an icon displayed in that position.

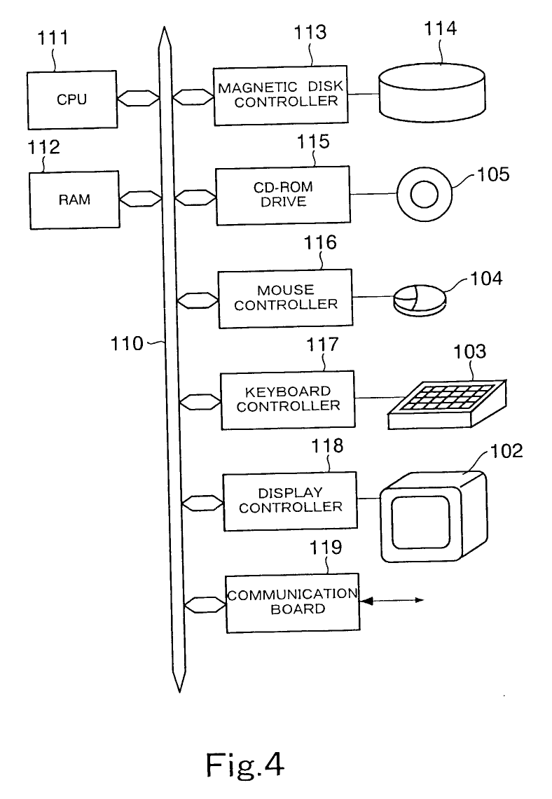

The main unit 101 also contains a CD-ROM drive for driving a CD-ROM 105 (see FIG. 4) removably loaded in it.

In this embodiment, an operation monitoring program is stored on the CD-ROM 105 and a main unit 101 is loaded with the CD-ROM 105. The operation monitoring program stored on the CD-ROM 105 is installed in the magnetic disk of the operation monitoring computer 100 by the CD-ROM drive. When the operation monitoring program installed in the magnetic disk of the operation monitoring computer 100 is activated, the operation monitoring computer 100 functions as the operation monitoring apparatus main unit according to one embodiment of the present invention.

FIG. 4 shows a hardware configuration diagram of the operation monitoring computer 100 shown in FIG. 3.

Shown in the hardware configuration diagram are a Central Processing Unit (CPU) 111, a RAM 112, a magnetic disk controller 113, a CD-ROM drive 115, a mouse controller 116, a keyboard controller 117 a display controller 118, and a communication board 119, which are interconnected through a bus 110.

The CD-ROM drive 115 is loaded with the CD-ROM 105 and accesses the CD-ROM 105, as described with reference to FIG. 3.

The communication board 119 is connected to a network system through communication equipment (not shown) and over the Internet or an intranet.

Also shown in FIG. 4 are the magnetic disk 114 accessed under the control of the magnetic disk controller 113, the mouse 104 controlled by the mouse controller 116, the keyboard 103 controlled by the keyboard controller 117, and the CRT display 102 controlled by the display controller 118.

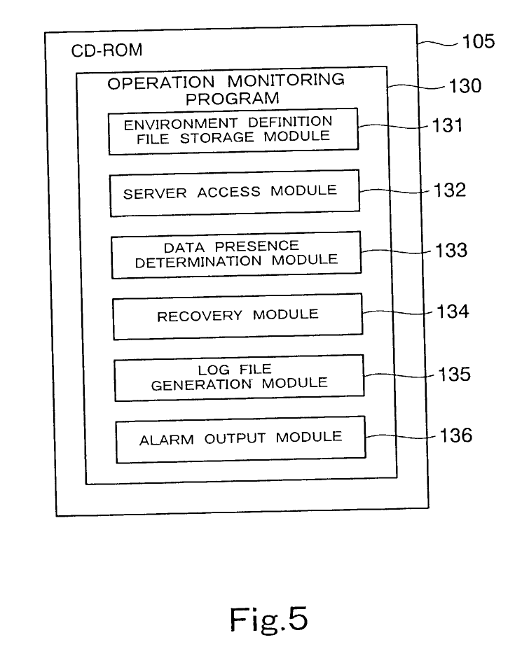

FIG. 5 schematically shows one embodiment of an operation monitoring program stored on a first operation monitoring program storage medium of the present invention.

In this embodiment, the operation monitoring program 130 is stored on the CD-ROM 105. The CD-ROM 105 is loaded in the operation monitoring computer 100 shown in FIG. 3 and FIG. 4 and driven, then the operation monitoring programs 130 and 140 stored on the CD-ROM 105 is installed in the operation monitoring computer 100 and executed to cause the operation monitoring computer 100 to operate as the operation monitoring apparatus according to the embodiment of the present invention. The operation monitoring program 130 shown in FIG. 5 may be referred to as a first operation monitoring program herein in order to distinguish the operation monitoring program 130 from a second operation monitoring program, which will be described later.

The operation monitoring program 130 shown in FIG. 5 includes an environment definition file 131, a server access module 132, a data presence determination module 133, a recovery module 134, a log file generation module 135, and an alarm output module 136.

The environment definition file storage module 131 corresponds to the environment definition file storage module 11 of the operation monitoring apparatus 10 shown in FIG. 1. The server access module 132 corresponds to the server access module 13 of the operation monitoring apparatus 10 shown in FIG. 1, the data presence determination module 133 corresponds to the data presence determination module 13 of the operation monitoring apparatus 10 shown in FIG. 1, the recovery module 134 corresponds to the recovery module 14 of the operation monitoring apparatus 10 shown in FIG. 1, the log file generation module 135 corresponds to the log file generation module 15 of the operation monitoring apparatus 10 shown in FIG. 1, and the alarm output module 136 corresponds to the alarm output module 16 of the operation monitoring apparatus 10 shown in FIG. 1. When the operation monitoring apparatus 10 shown in FIG. 1 is formed by the operation monitoring computer 100 shown in FIGS. 3 and 4 and operation monitoring program 130, shown in FIG. 5, installed in it, all of the environment definition file storage module 11 of the operation monitoring apparatus 10 shown in FIG. 1, server access module 12, data presence determination module 13, recovery module 14, log file generation module 15, and alarm output module 16 are implemented by a combination of the hardware of the computer, OS (operating system), and operation monitoring program, which is an application program. In contrast, the operation monitoring program 130 shown in FIG. 5 is implemented by the application program alone. The functions of the components of the operation monitoring program 130 in FIG. 5 are the same as those of the corresponding components of the operation monitoring apparatus 10 in FIG. 1 and therefore the description of which will be omitted.

An operation monitoring program stored in a second operation monitoring program storage medium according to the present invention will be described below. The operation monitoring program 140 (which is referred to as a second operation monitoring program herein) has an environment definition file storage module, which corresponds to the environment definition file storage module 21 of the second operation monitoring apparatus 20 of the present invention shown in FIG. 2, instead of the environment definition file storage module 131 of the first operation monitoring program 130 shown in FIG. 5. The environment definition file storage module of the second operation monitoring program according to the present invention stores an environment definition file including information identifying application programs for retrieving data used for operation monitoring from among data contained in databases 5A and 5B included in and accessed by servers 2A, 2B, 2C, . . . connected over a communication line 6 (see FIG. 2) and associated with information identifying the data to be retrieved from the databases 5A and 5B by the application programs.

Except for the environment definition file storage module, the components of the second operation monitoring program, that is, the server access module, data presence determination module, recovery module, log file generation module, and alarm output module are the same as the server access module 132, data presence determination module 133, recovery module 134, log file generation module 135, and alarm output module 136, respectively, of the first operation monitoring program of the present invention.

Operation of the operation monitoring apparatus and the operation monitoring program stored on the operation monitoring program storage medium in the present invention will be described below.

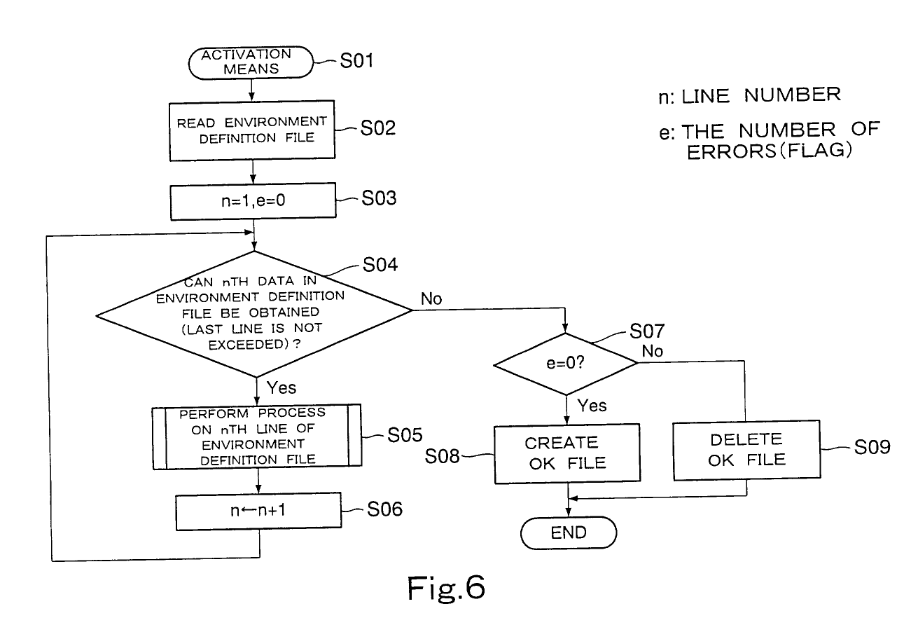

FIG. 6 shows a main flowchart of an operation of the operation monitoring apparatus according to this embodiment.

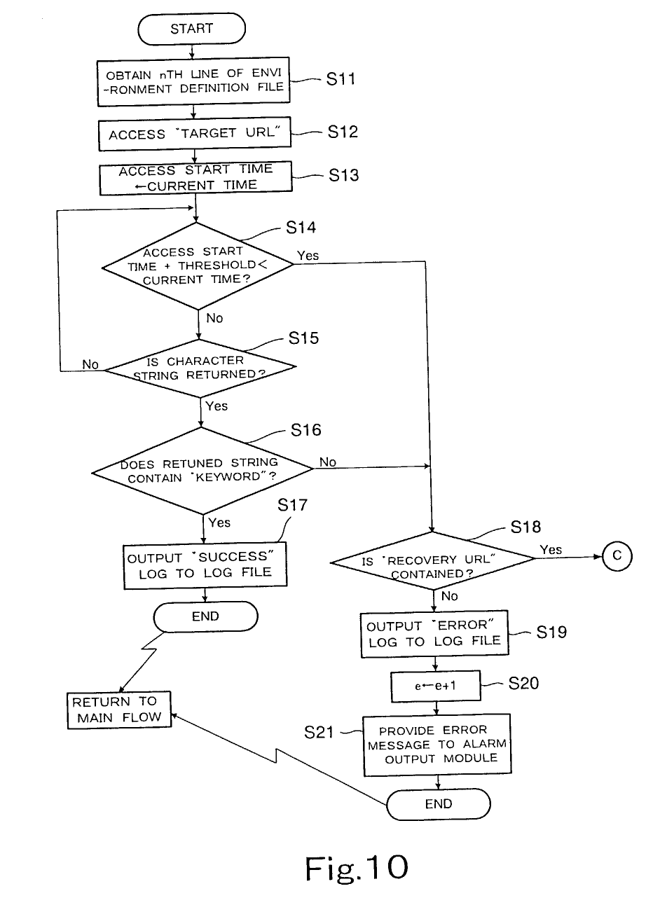

The operation monitoring apparatus in flowchart shown in FIGS. 6 and 10 corresponds to the second operation monitoring apparatus of the present invention. The operation steps of the first operation monitoring apparatus of the present invention is the same as those shown in the flowcharts shown in FIGS. 6 and 10, except steps relating to the environment definition file storage module.

When the operation monitoring apparatus 20 (see FIG. 2) is activated (step SOL), the environment definition file 27 stored in the operation monitoring apparatus 20 starts to be read (step S02).

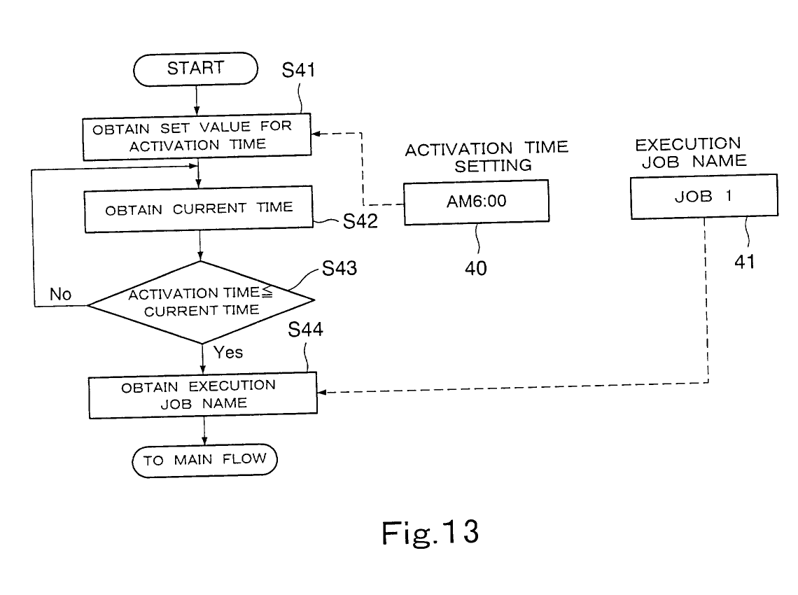

Means for activating the operation monitoring apparatus may be a time-of-day activator as shown in FIG. 13. Details of the operation of the time-of-day activator will be described later.

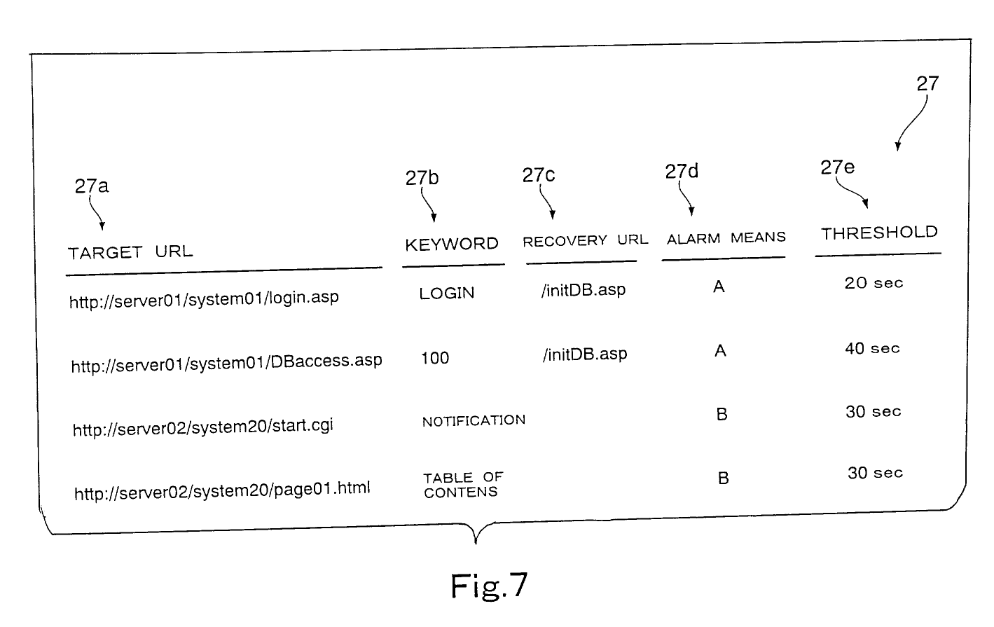

FIG. 7 shows a part of the environment definition file according to this embodiment.

As shown in FIG. 7, the environment definition file 27 associates information identifying a file accessed for operation monitoring among files in servers 2A, 2B, 2C, . . . connected to the operation monitoring apparatus 20 with information identifying data contained in that file. A subject URL column 27a, keyword column 27b, recovery URL column 27c, alarm means column 27d, threshold column 27e, and other columns are provided in the environment definition file 27.

The subject URL column 27a contains the addresses of servers on a network system that are monitored by the operation monitoring apparatus. As illustrated in FIG. 7, server addresses such as “http://server01/system01/login.asp” are contained. “.asp” in the subject URL column in FIG. 7 is an extension indicating active server pages and “.html” is an extension indicating hyper text markup language. It also indicates the CGI (Common Gateway Interface).

They keyword column 27b contains “data identified in the environment definition file stored in the environment definition file storage module” as referred to herein. It contains character strings such as “Login”, “100”, “Notification” and “Table of contents”, as show in FIG. 7.

The recovery URL column 27c stores information identifying recovery means used for causing a server to perform recovery if the server contains no keyword column 27b described above. As illustrated in FIG. 7, it contains character strings such as “/initDB.asp” or is blank. “initDB.asp” represents a type of tool for initializing connection to an RDBMS (Relational Database Management System).

The alarm means column 27d contains alarm means that output an alarm if data (identified in the environment definition file) obtained through a monitored server does not contain a required character string. As shown in FIG. 7, it contains characters such as “A” and “B”.

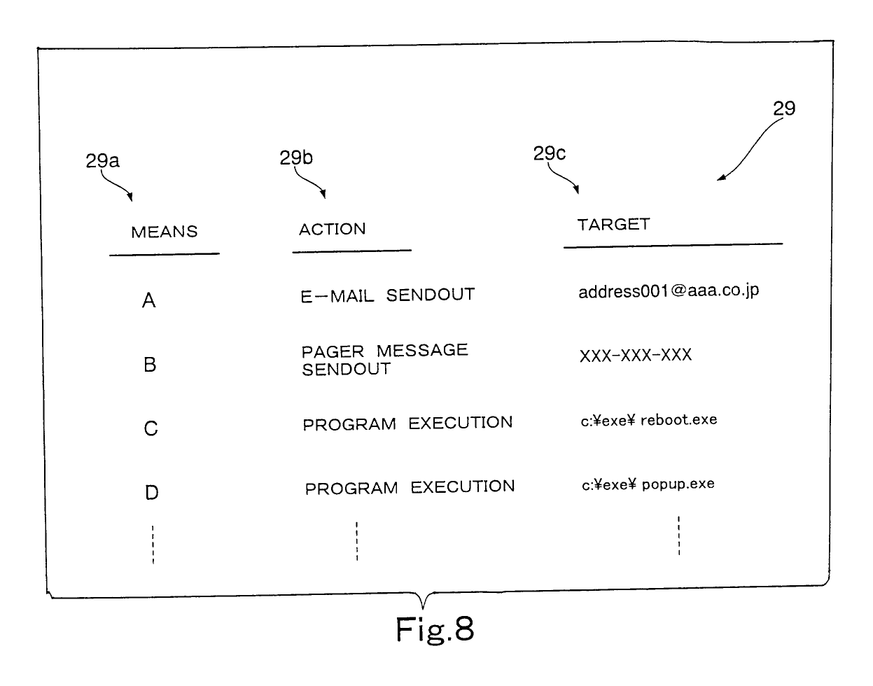

The characters such as “A” and “B” contained in the alarm means column 27d indicate alarm information as shown in an alarm information list 29 in FIG. 8.

FIG. 8 shows a part of an alarm information list according to this embodiment.

Provided in the alarm information list 29 shown in FIG. 8 are a means column 29a, action column 29b, and target column 29c. The alarm action of character A in the means column 29a is “e-mail sendout”, as shown in the action column 29b, and its target is “address001@aaa.co.jp”.

Likewise, the alarm action of character B is a “pager message sendout” and the target of the pager is “XXX-XXX-XXXX”. The alarm action of character C is “program execution” and the program is “c:¥exe¥reboot.exe”. The alarm action of character D is “program execution” and the program is “c:¥exe¥popup.exe”.

Execution of program “reboot.exe” in character C indicates that the program for rebooting the system is executed and the execution of program “popup.exe” in character D indicates that a program for displaying a message on a display is executed.

The threshold column 27e in the environment definition file 27 shown in FIG. 7 contains allowable time between the start of access by the operation monitoring apparatus to a monitored server and the retrieval of a file from that server.

At step S03 in the main flowchart in FIG. 6, the line number, n, of the environment definition file 27 and the number, e, of errors are initialized to “1” and “0”, respectively. Then, it is determined whether the nth line of the environment definition file 27 can be obtained (step S04). If it can be obtained, a process (which will be described later) is performed based on data on the nth line (step S05), 1 is added to valuable n at step S06, then process returns to step S04 for obtaining data.

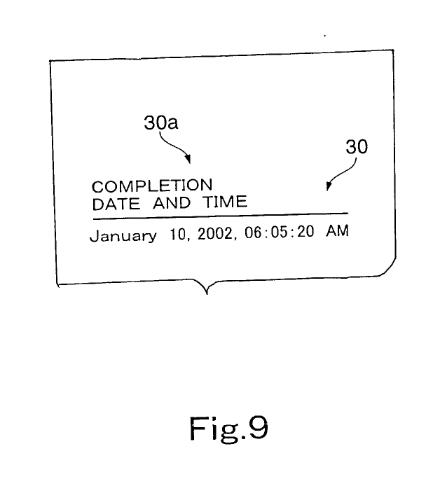

If it is determined at step S04 that data on the last line of the environment definition file has obtained, then the process proceeds to step S07, where it is determined whether number e of errors is “0”. That is, it is determined whether files obtained by the server access module 12 (see FIG. 2) of the operation monitoring apparatus from servers 2A, 2B, 2C, . . . contain data identified by the environment definition file 27, that is, data contained in the keyword column 27b (see FIG. 7). If the data is contained, an “OK file” (see FIG. 9) is created (step S08), then the process ends. On the other hand, if the data is not contained, an associated “OK file” is deleted (step S09), then the process ends.

FIG. 9 shows the content of the OK file used in this embodiment.

As shown in FIG. 9, a completion date and time column 30a contains access completion time and date, “Jan. 10, 2002; 06:05:20 AM”, for example.

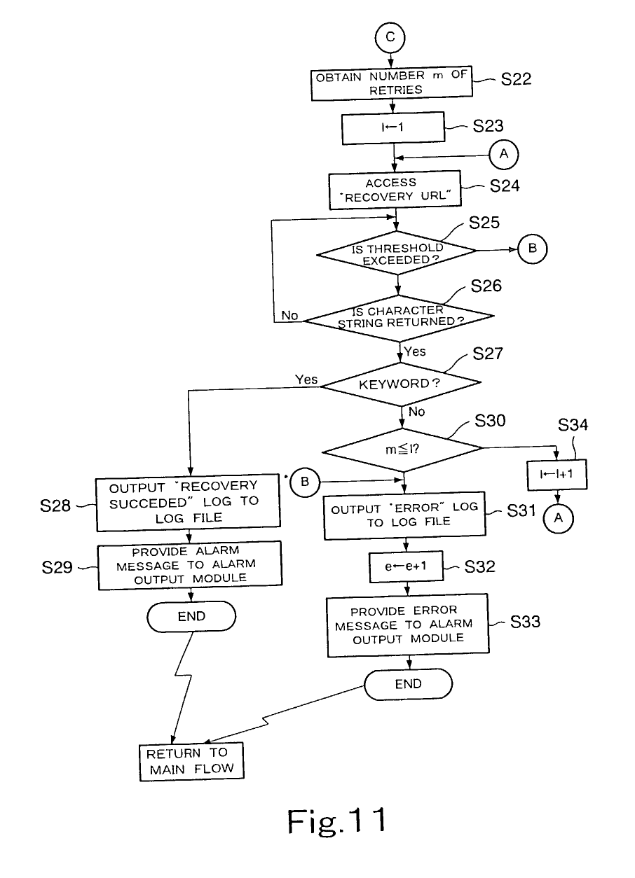

FIGS. 10 and 11 show flowcharts, which are part of the main flowchart shown in FIG. 6 and indicate a “process on the nth line” in FIG. 6.

As shown in FIG. 10, data on the nth line of the environment definition file 27 is first obtained in the “process on the nth line” (step S11). Then, the server access module 22 (see FIG. 2) accesses a server having an address contained in the target URL column 27a in the nth line data to retrieve a file contained in the server and identified in the environment definition file 27 (step S12) and sets the “access start time” to the current time (step S13).

Then, data in the threshold column 27e (see FIG. 7) is added to the “access start time” and the sum is compared with the current time (step S14). If the sum does not reaches the current time, the process proceeds to step S15. If the sum reaches the current time, the process proceeds to step S18.

At step 15, the server access module 22 determines whether a character string is returned by the server. If no character string is returned, the process returns to step S14. If a character string is returned, it is determined whether the returned character string contains data identified in the environment definition file 27, that is, a keyword (step S16). If the determination at step S16 shows that the keyword is contained, the process proceeds to step S15, where a “success log” record is output to the log file 28 (see FIG. 2), then the process returns to the main flowchart (FIG. 6). On the other hand, if the determination at step S16 shows that no keyword is contained, the process proceeds to step S18, where it is determined whether the nth line of the environment definition file 27 (see FIG. 7) contains a recovery URL column 27c (step S18).

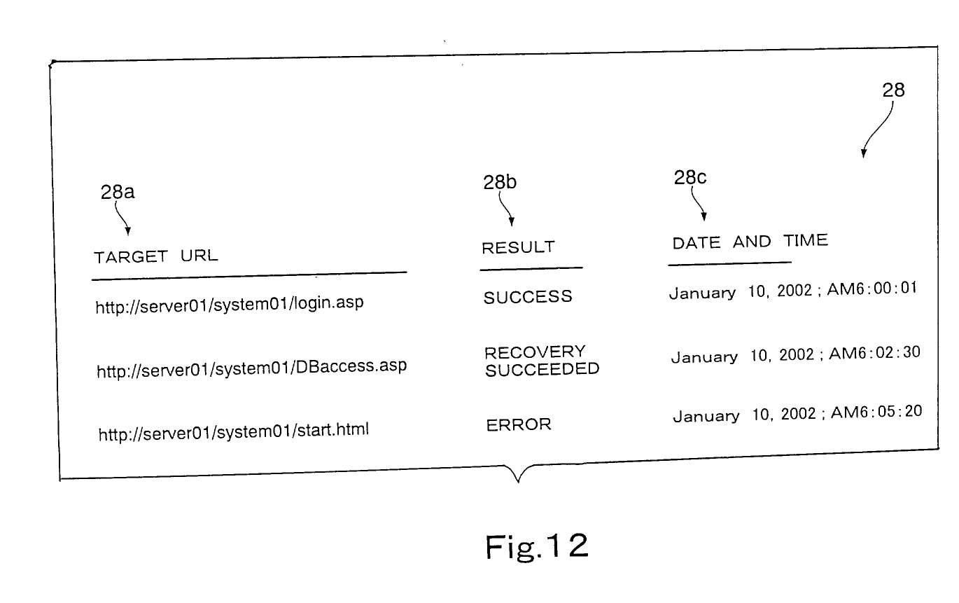

If the determination at step S18 shows that no data is contained in the recovery URL column 27c, the process proceeds to step S19. At step S19, an “error log” record is output to the log file 28 (see FIG. 2) shown in FIG. 12, then the process proceeds to step S20.

FIG. 12 shows a part of the log file used in this embodiment.

As shown in FIG. 12, provided in the log file 28 are a target URL column 28a, a result column 28b, and a date and time column 28c.

The target URL column 28a contains the URLs of servers to be accessed, for example “http://server01/system01/login.asp”.

The result column 28b contains a “success” log record if the access succeeds, or a “recovery succeeded” log record if the recovery succeeds, or “error” log record if the access results in an error.

The date and time column 28c contains the date and time at which the access is performed, for example “Jan. 10, 2002; 06:00:01 AM.”

At step S20 (see FIG. 10), 1 is added to number e of errors, an error message is provided to the alarm output module 26 (see FIG. 2) (step S21), then the process returns to the main flowchart (see FIG. 6).

On the other hand, if the determination at step S18 shows that a recovery URL is contained in the environment definition file 27 shown in FIG. 7, the process proceeds to step S22 in FIG. 11.

At step S22 in FIG. 11, the maximum value m of the number of access retries, which is preset in a predetermined memory location, is obtained.

Then, number 1 of retires is set to its initial value 1 (step S23). The recovery URL column 27c is accessed (step S24) and the arrival of a character string returned from the accessed server is waited until a threshold stored in the environment definition file 27 shown in FIG. 7 is exceeded (steps S25 and S26). If the character string is returned, the process proceeds to step S27 and it is determined whether it contains a keyword stored in the environment definition file 27 shown in FIG. 7. If the threshold is exceeded at step S25, the process jumps to a routine illustrated at step S31 and the subsequent steps.

If the determination at step S27 shows that it contains the keyword, the process proceeds to step S28, where a “recovery succeeded” log record is provided to the result column 28b of the log file 28 (see FIG. 2) (step S28), an alarm message is provided to the alarm output module 26 (see FIG. 2) (step S29), then process returns to the main flowchart (see FIG. 6).

On the other hand, if the determination at step S27 shows that no keyword is contained, it is determined whether number 1 of retires is less than maximum number m of retries at step S30. If number 1 of retries is less than maximum number m of retries, then 1 is added to number 1 of retries and the process returns to step S24, and access is repeated.

Moreover, if the determination at step S30 shows that number 1 of retires reaches maximum number m of retires, an “error” is outputted to the result column 28b of the log file 28 (see FIG. 2) (step S31), 1 is added to number e of errors (step S32), an error message is provided to the alarm output module 26 (see FIG. 2) (step S33), then the process returns to the main flowchart (see FIG. 6).

FIG. 13 shows a flowchart of a process performed by a time-of-day activator used with the operation monitoring apparatus of the present embodiment.

As shown in FIG. 13, in the time-of-day activator, a setting, “06:00 AM” for example, for activation time stored in a predetermined memory location 40 is obtained (step S41). Then, the current time is obtained (step S42). If the current time reaches the activation time-of-day (step S43), an execution job name, “job 1”, for example, stored in a predetermined memory location 41 is obtained (step S44) and then the process of the main flow (see FIG. 6) is started.

As described above, the first operation monitoring apparatus of the present invention can automatically and reliably monitor operations of servers connected through a communication line, by using the environment definition file storage module, server access module, and data presence determination module provided in it.

The second operation monitoring device of the present invention can automatically and reliably monitor operations of databases accessed by servers connected through a communication line, by using the environment definition file storage module, server access module, and data presence determination module provided in it.

Further, the operation monitoring program stored in the operation monitoring program storage medium according to the present invention can easily configure the operation monitoring apparatuses as described above on a computer.

What is claimed is:

1. An operation monitoring apparatus for monitoring an operation of a server connected through a communication line, comprising:
an environment definition file storage module for storing an environment definition file including information identifying a file to be accessed for operation monitoring among files contained in the server connected through the communication line and information identifying data contained in said file, said information identifying said file being associated with said information identifying said data;
a server access module for accessing said server to retrieve a file identified in the environment definition file stored in said environment definition file storage module in said server; and
a data presence determination module for determining whether the file retrieved by said server access module contains the data identified in the environment definition file stored in said environment definition file storage module.

2. An operation monitoring apparatus for monitoring an operation of a database accessed by a server connected through a communication line, comprising:
an environment definition file storage module for storing an environment definition file including information identifying an application program for retrieving data used for operation monitoring among data contained in the database accessed by said server connected through the communication line and information identifying data to be retrieved by said application program from said database, said information identifying said application program being associated with said information identifying said data,
a server access module for accessing said server to activate the application program identified in the environment definition file stored in said environment definition file storage module in said server and obtaining the data from said database through said server; and
a data presence determination module for determining whether the data obtained by said server access module contains the data identified in the environment definition file stored in said environment definition file storage module.

3. The operation monitoring apparatus according to claim 1 or 2, wherein said environment definition file allows information to be described in said environment definition file for identifying recovery means for causing the server to perform recovery; and
the operation monitoring apparatus further comprises a recovery module for causing the server to perform recovery based on the information identifying said recovery means if said data presence determination module determines that the data identified in the environment definition file is not contained.

4. The operation monitoring apparatus according to claim 1 or 2, further comprising a log file generation module for generating a log file for logging the result of determination made by said data presence determination module.

5. The operation monitoring apparatus according to claim 1 or 2, wherein said environment definition file allows alarm information to be described in said environment definition file; and the operation monitoring apparatus further comprises an alarm output module for outputting an alarm based on said described alarm information if said data presence determination module determines that the data identified is not contained.

6. The operation monitoring apparatus according to claim 1 or 2, wherein said server is a WWW server.

7. The operation monitoring apparatus according to claim 1 or 2, wherein information in said environment definition file for identifying the file or application program is a URL.

8. An operation monitoring program storage medium storing an operation monitoring program causing a computer to operate as an operation monitoring apparatus for monitoring the operation of a server connected to said computer through a communication line,
wherein said operation monitoring apparatus comprises:
an environment definition file storage module for storing an environment definition file including information identifying a file to be accessed for operation monitoring among files contained in the server connected through the communication line and information identifying data contained in said file, said information identifying said file being associated with said information identifying said data;
a server access module for accessing said server to retrieve a file identified in the environment definition file stored in said environment definition file storage in said server; and
a data presence determination module for determining whether the file retrieved by said server access module contains the data identified by the environment definition file stored in said environment definition file storage module.

9. An operation monitoring program storage medium storing an operation monitoring program for causing a computer to operate as an operation monitoring apparatus for monitoring the operation of databases accessed by a server connected to said computer through a communication line,
wherein said operation monitoring apparatus comprises:
an environment definition file storage module for storing an environment definition file including information identifying an application program for retrieving data used for operation monitoring among data contained in the database provided in and accessed by said server connected through the communication line and information identifying data to be retrieved by said application program from said database, said information identifying said application being associated with said information identifying said data,
a server access module for accessing said server to activate application program identified in the environment definition file stored in said environment definition file storage module in said server and obtaining the data from said database through said server; and
a data presence determination module for determining whether the data obtained by said server access module contains the data identified in the environment definition file stored in said environment definition file storage module.
